(19) United States
(12) Patent Application Publication
(10) Pub. No.: US 2005/0134673 A1
(43) Pub. Date: Jun. 23, 2005

(54) Printer paper for tachographs

(75) Inventor: Ernst Bendek, Koenigsfeld (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, Munich (DE)

(21) Appl. No.: 11/031,009

(22) Filed: Jan. 10, 2005

Related U.S. Application Data
(63) Continuation of application No. PCT/DE03/02036, filed on Jun. 18, 2003.

(30) Foreign Application Priority Data
Jul. 17, 2002 (DE) 102 32 391.7

(51) Int. Cl. B41J 17/00; B41J 2/325

(52) U.S. Cl. 347/215

(57) ABSTRACT

The present invention relates to printer paper for a tachograph, the paper having a front and a rear side. The front side can be printed on by a printer of the tachograph. The rear side is provided with at least one matrix for manual recordings.

### CROSS REFERENCE TO RELATED APPLICATIONS

The present application is a continuation of international application PCT/DE03/02036, filed Jun. 18, 2003, which is pending and designated the United States, and further claims priority to German patent application 10232391.7, filed Jul. 17, 2002, the both of which are herein incorporated by reference.

### BACKGROUND OF THE INVENTION

The invention relates to a printer paper for a tachograph, having a front and a rear side, it being possible for the front side to be printed by a printer of the tachograph.

Tachographs have the object of meeting the statutory requirement of keeping recordings about the traveling times, working times, standby times and rest times of vehicle drivers. At the same time, it is the object of tachographs to log the speed of a vehicle continuously. Therefore, vehicle speeds and working, traveling, rest or standby times can always be assigned unambiguously to a driver.

In the event of failure of the tachograph, the statutory obligation on the vehicle driver to log traveling times, working times, standby times and rest times is maintained. This log must always be maintained and up to date. However, if the tachograph is defective, then the vehicle driver only has the possibility of replacing this statutorily prescribed log by means of manual recordings. In this case, the vehicle driver is often faced with the problem of not having any suitable medium, such as a sheet of paper, with him or, during the recording, of forgetting one or another important detail.

### SUMMARY OF THE INVENTION

The object of the invention is to provide a solution for this and to ease the situation for the vehicle driver.

This object is achieved in that a printer paper for a tachograph, having a front and a rear side is provided, it being possible for the front side to be printed by a printer of the tachograph and the rear side of the printer paper being provided with at least one matrix for manual recordings.

The advantage with this configuration of the printer paper is that, in the event of failure of the tachograph, the vehicle driver has a suitable medium to hand which, at the same time, assists him in meeting his statutory obligation to record traveling times, working times, standby and rest times, even in the event of failure of the tachograph. In this case, the matrix additionally assists him not to forget any detail which he is obliged to record. Thus, in an advantageous embodiment, the rear side of the printer paper not only contains a matrix for time recordings but also fields assigned to the matrix for the recording of information such as, for example, the name of the vehicle driver, the card number of the vehicle driver and the current date.

It is usual to make the recordings over an entire day or over 24 hours. According to the invention, this is taken into account in that the matrix has sufficient columns to depict the 24 hours of a day with an accuracy of half an hour.

In this case, it is advantageous and additionally assists the driver that at least each column separating line that marks a full hour is labeled with a number which designates the hour.

The vehicle driver is obliged not only to log traveling times but also working times, these can be times for the loading or unloading of his vehicle, and also other working times. Furthermore, he is obliged to log the time at which he was standing by and he is also obliged to make a report relating to his rest times. For this reason, it is expedient to lay out the matrix in at least four rows, so that the vehicle driver can keep a log about these four different times, by providing one row for traveling time, one row for other working times, one row for standby times and one row for rest times.

A further advantageous embodiment of the printer paper makes provision, in the sense of independence of language, to mark the individual matrix rows with pictograms symbolizing the corresponding activities to be logged. If the printer paper has sufficient space, it is also possible to list more than one of the aforementioned matrices at a suitable distance from one another.

The idea of the invention comprises not only printer paper and tachographs in general but also printer paper for digital and/or analog tachographs in page-by-page single-sheet form or else in roll form.

The printer paper according to the invention additionally provides the possibility of storing and imparting further information via the matrix for recording statutorily required logs. For example, one embodiment of the invention provides for information about the certification mark of the printer paper, and about the certification mark of the tachograph certified for this printer paper to be applied to the margins of the printer paper.

Furthermore, there is the possibility of backing the front side of the printer paper according to the invention with transparent but nevertheless legible information about the manufacturer of the paper and of the tachograph. It can be seen that the type of information transmitted can be flexible and is not restricted to the examples mentioned above. It can likewise be seen that the printer paper according to the invention contains at least the statutorily required information and logging possibilities.

One advantageous development of the invention provides for the printer paper to be rolled up on a coil as an elongated strip of about 6 m to 10 m, preferably 7.5 m. A length dimension of this type firstly ensures an adequate size format for machine recordings but also, if necessary, manual recordings and secondly the supply of rolled-up printer paper is sufficient for a sufficiently long time interval.

The coil advantageously has a diameter of about 25 mm to 30 mm, preferably a diameter of 27.5⁺¹ mm, since such a diameter has good compatibility with appropriate printing units. Likewise in the interests of far-reaching compatibility, the printer paper is provided with a thermal layer to be printed on the side of the coil that points outward. For an adequate supply of printing paper, in particular on a coil, with a simultaneously adequate resistance against mechanical stresses, the printer paper has a thickness of about 0.05 mm to 0.07 mm, preferably a thickness of 0.066 mm, which is also conducive to the function of appropriate printing units.

For easy handling, small space requirement during storage and nevertheless adequate legibility, the printer paper has a width of about 50 mm to 70 mm, preferably matched to appropriate printing units of about 58 mm.

Since the printer paper according to the invention can be used with an extremely small format, manual recording in the event of failure of the instrument, in particular under the adverse conditions of the driver's cab of the motor vehicle, presents great difficulties, for which reason, according to the invention, the matrix on the rear side has rows and columns, the columns extend in the longitudinal direction of the printer paper and the columns extend in the transverse direction of the printer paper, along the rows a time scale is reproduced by means of labeling, and various activities corresponding to the statutory regulations are reproduced along the columns. Only such preparation of the recording matrix permits a recording on the small-format printer paper which satisfies the statutory regulations since, according to the invention, only markings are entered into the matrix and no clock times or activities have to be entered in a text which bears information. To this extent, the invention makes the purely technical handling of the printer paper easier during manual recording.

For the matrix according to the invention, an extent of about 80 mm to 100 mm along the longitudinal direction of the printer paper has proven to be an advantageous format. The symbols or numbers with which the matrix is labeled are expediently arranged to be read in the longitudinal direction.

The information can be entered on the printer paper in a particularly space-saving manner in that the matrix is divided up into two matrices arranged beside each other in the transverse direction, since the amount of information in the time direction during a 24-hour working day is more than twice as large as the information about the type of activity required by law.

In particular in the form of the printer paper as a coil, it is expedient if a plurality of matrices are arranged one after another in the longitudinal direction. At least one field for the driver's name, a card number, the current date and/or a signature is preferably provided between matrices arranged in the longitudinal direction. In this way, the entries in the matrix can always be assigned correctly.

In the following text, the invention is explained in more detail with reference to two figures and an exemplary embodiment.

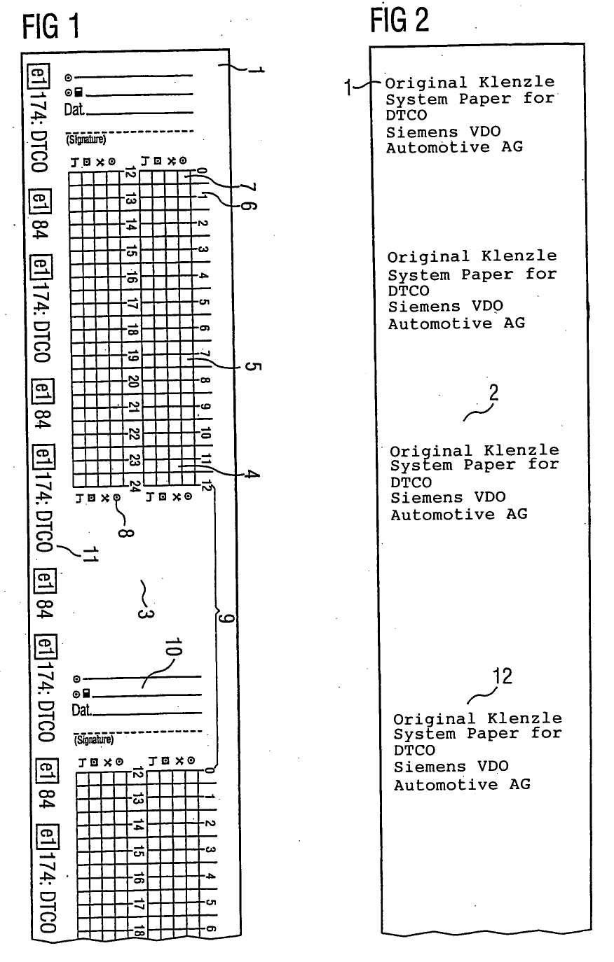

FIG. 1 shows the rear side of the printer paper.

FIG. 2 shows the front side of the printer paper.

FIG. 1 shows a detail of a rear side 3 of a roll-form printer paper 1 in the unwound state. The rear side 3 of the printer paper 1 bears on one side certification marks 11 for the tachograph and certification marks 11 for the paper. It is also possible to see the 24-hour subdivision of the matrix 4 by means of an appropriate number of columns 5. The latter are separated from one another by column separating lines 6. The column separating lines have the designation of each individual hour.

The exemplary embodiment of the strip shown here of a printing paper roll also shows the possibility of applying more than one matrix, for example any desired number of matrices distributed at uniform intervals over the entire length of the printing paper, two matrices always being at a distance 9 from each other.

The matrix has associated fields 10, in which the vehicle driver can enter his name, his card number and the current date and his signature.

The front side 2 of the printer paper 1, illustrated in FIG. 2, clearly shows the possibility of storing further references on the printer paper without in the process disregarding the statutory minimum requirements on activities and information to be logged.

1. Printer paper for a tachograph, the printer paper being windable about a roll, comprising: a front side and rear side, the front side arranged to be printed upon by a printer of the tachograph, and the rear side is provided with a plurality of matrices arranged one after another in a longitudinal direction for manual recordings.

2. The printer paper according to claim 1, wherein each of the matrices is assigned at least as many fields as necessary to accommodate statutorily prescribed information relating to vehicle driver, the information including name, card number of the vehicle driver, and date.

3. The printer paper according to claim 1, wherein each of the matrices comprises a sufficient number of columns to depict 24 hours with an accuracy of half an hour.

4. The printer paper according to claim 3, wherein at least a first column includes a separating line marking a full hour and provided with a label indicating the hour.

5. The printer paper according to claim 1, wherein each of the matricies includes at least four rows arranged so as to depict four activities of the vehicle driver.

6. The printer paper according to claim 5, wherein each row is provided with standardized pictograms to symbolize “traveling time”, “other working time”, “standby time” and “rest time”, the pictograms being located at the start and/or end of a row.

7. The printer paper according to claim 1, further comprising fields provided with standardized pictograms for statutorily prescribed information.

8. The printer paper according to claim 1, further comprising at least one certification mark for the tachograph and/or for the printer paper, the mark being printed on at least one margin.

9. The printer paper according to claim 1, further comprising a “watermark” which can be detected at least on the front side and which names a manufacturer of the printer paper and/or a manufacturer of the tachograph.

10. The printer paper according to claim 1, wherein said paper is printable by printers for both analog and digital tachographs.

11. The printer paper according to claim 1, wherein the paper is rolled up on a coil as an elongated strip of about 6 m to 10 m.

12. The printer paper according to claim 11, wherein the coil has a diameter of about 25 mm-30 mm.

13. The printer paper according to claim 11, wherein an area to be printed is located on a side of the coil that points outward and is provided with a thermal layer.

14. The printer paper according to claim 1, wherein the printer paper has a thickness of about 0.05 mm to 0.07 mm.

15. The printer paper according to claim 1, wherein the paper comprises a width of about 50 mm-70 mm.

16. The printer paper according to claim 1, wherein each of the matrcies, on the rear side, has rows and columns, the rows extending in the longitudinal direction of the printer paper and the columns extending in the transverse direction of the printer paper, along the rows a time scale is reproduced by means of labeling, and various activities corresponding to the statutory regulations are reproduced along the columns.

17. The printer paper according to claim 1, wherein each of the matricies extends about 80 mm-100 mm along a longitudinal direction of the printer paper.

18. The printer paper according to claim 1, wherein each of the matricies is labeled with symbols and/or numbers and the labeling is arranged to be legible in a longitudinal direction.

19. The printer paper according to claim 1, wherein each of the matricies is divided up into two matrices arranged beside each other in the transverse direction.

20. The printer paper according to claim 1, wherein at least one field for a driver's name, a card number, a current date and/or a signature is provided between matrices arranged in a longitudinal direction.
